(19) United States
(12) Patent Application Publication
(10) Pub. No.: US 2024/0427616 A1
(43) Pub. Date: Dec. 26, 2024

(54) Systems And Methods For Identifying And Translating Changes In User Interface Text For A Software Application

(71) Applicant: CLIMATE LLC, Saint Louis, MO (US)

(72) Inventors: Max BUSTER, Seattle, WA (US); Chris PICK, Spokane, WA (US); Brendan CLAVIN, Tucson, AZ (US); Russell COLLINS, Lynnwood, WA (US); Bruno T. NASCIMENTO, Chicago, IL (US)

(21) Appl. No.: 18/692,320

(22) PCT Filed: May 27, 2022
(86) PCT No.: PCT/US2022/072620

§ 371 Date: Mar. 14, 2024

Related U.S. Application Data
(60) Provisional application No. 63/245,097, filed on Sep. 16, 2021.

(51) Int. Cl. G06F 9/451; G06F 40/106; G06F 40/137; G06F 40/226; G06F 40/279; G06F 40/47; G06F 40/51

(52) U.S. Cl. CPC G06F 9/454; G06F 40/106; G06F 40/137; G06F 40/226; G06F 40/279; G06F 40/47; G06F 40/51

(57) ABSTRACT

Disclosed herein are systems and methods for translating and verifying text in a variety of different languages for the same software application. When the text in the application changes. embodiments of the disclosure may include translating and/or verifying only the text that has changed. The system may compare the new screenshot(s) with previously accepted screenshot(s) to locate the text that has changed. The text that has not changed (since the last accepted translation) may not be translated and/or verified once accepted by a translator. The system may highlight the text that has changed so that the translator may focus only on the relevant portions of the user interface and not have to search for the text that has changed. For rejected translations. the system may repeat the process. translating and/or verifying only the rejected text (instead of translating/verifying all text again).

### CROSS-REFERENCE TO RELATED APPLICATION

This application claims the benefits of U.S. provisional application No. 63/245,097, filed Sep. 16, 2021, the contents of which are incorporated herein by reference in its entirety for all purposes.

### FIELD

The present disclosure relates generally to systems and methods of translating text for software applications.

### BACKGROUND

The same software application may be used in a variety of different countries and/or with a variety of different users that speak different languages. Updating the software application to appropriately display text in a variety of different languages creates a number of problems. These include inappropriate translations that make the software application look and feel unprofessional or confusing and requiring extensive time for translators to sort through the text in the software application to make appropriate translations.

Traditional systems and methods may use a third-party translator to translate text defined in raw text files. These translations however may only be accurate in certain contexts. The accuracy of the translation may be limited to the information in the raw text files, and thus, limited due to not having information regarding the complete context of how the text is used in the software application. A translator may be needed to manually verify the translation results from the translator. This process can be time consuming and costly because it requires a deep understanding of how the software application works as well as a broad verification to ensure text throughout the software application and associated user interfaces in all languages of interest are correct. The translator often has to navigate through the app, and locate and verify each text, even if previously translated and verified. The process is inefficient and does not scale as the number of countries and languages of interest (e.g., supported languages for the software application) increases.

In some scenarios, linguist test engineers may perform regression test cases in each language while simultaneously verifying that all text appears correct in the given language. This method however is still inefficient, requiring a massive amount of manual tasks and resulting in many translation issues disguised as bugs, ultimately slowing down the regression tests.

The process involved with these traditional translation methods must be repeated every time text for the software application changes. The text may change (e.g., additions, edits, updates, etc.) frequently, making the associated inefficiencies even more problematic.

What is needed is a system and method capable of reducing the time and cost in accurately translating text for software applications. The system and method may identify only text that have changed since the last accepted translation.

### BRIEF SUMMARY

A method for translating or verifying text of a software application is disclosed. The method may comprise: receiving one or more new screenshots, one or more new hierarchy files, or both, of the software application; retrieving one or more previously accepted screenshots, one or more previously accepted hierarchy files, or both; comparing the one or more new screenshots with the one or more previously accepted screenshots, or the one or more new hierarchy files with the one or more previously accepted hierarchy files; locating text that has changed based on an output of the comparison; presenting a translation of the text that has changed to a translator for acceptance or rejection of the translation; and storing the one or more new screenshots, the one or more new hierarchy files, or both, when the translation has been accepted. Additionally or alternatively, in some embodiments, the one or more previously accepted screenshots and the one or more previously accepted hierarchy files are from a last translation and verification for the same user interface of the software application. Additionally or alternatively, in some embodiments, the method further comprises: applying one or more exceptions to the comparison, the one or more exceptions excluding at least one text from the output of the comparison. Additionally or alternatively, in some embodiments, the comparing the one or more new hierarchy files with the one or more previously accepted hierarchy files comprises: parsing the one or more new hierarchy files; and parsing the one or more previously accepted hierarchy files, wherein the comparing the one or more new hierarchy files with the one or more previously accepted hierarchy files comprises performing a plain text comparison of the parsed one or more new hierarchy files and the parsed one or more previously accepted hierarchy files. Additionally or alternatively, in some embodiments, the comparing comprises determining differences in page structure, element structure, or images. Additionally or alternatively, in some embodiments, the presenting the translation of the text that has changed comprises highlighting previous text in the one or more previously accepted screenshots, one or more previously accepted hierarchy files, or both, and highlighting the text that has changed in the one or more new screenshots, the one or more new hierarchy files, or both. Additionally or alternatively, in some embodiments, the method further comprises: presenting a change history of the one or more new screenshots to the translator. Additionally or alternatively, in some embodiments, the method further comprises: collecting and capturing the one or more new screenshots, the one or more new hierarchy files, or both, of the software application. Additionally or alternatively, in some embodiments, the one or more new screenshots collected are not for all languages of interest. Additionally or alternatively, in some embodiments, the collecting and capturing comprises iterating through every user interface of the software application. Additionally or alternatively, in some embodiments, the method further comprises: determining that at least one screenshot does not have the text that has changed; and discarding the at least one screenshot, a corresponding at least one hierarchy file, or both. Additionally or alternatively, in some embodiments, the method further comprises: submitting a translation request of the text that has changed to the translator; and receiving the translation of the text that has changed from the translator. Additionally or alternatively, in some embodiments, the submitting the translation request comprises sending one or more files to the translator, the one or more files including only the text that has changed.

A system for translating text of a software application is disclosed. The system comprises: a memory that stores one or more previously accepted screenshots, one or more previously accepted hierarchy files, or both; a processor that: receives one or more new screenshots, one or more new hierarchy files, or both, of the software application; retrieves the one or more previously accepted screenshots, the one or more previously accepted hierarchy files, or both from the memory; compares the one or more new screenshots with the one or more previously accepted screenshots, or the one or more new hierarchy files with the one or more previously accepted hierarchy files; stores the one or more new screenshots, the one or more new hierarchy files, or both, when the translation has been accepted; and locates text that has changed based on an output of the comparison; and a display that presents a translation of the text that has changed to a translator for acceptance or rejection of the translation. Additionally or alternatively, in some embodiments, the one or more previously accepted screenshots and the one or more previously accepted hierarchy files are from a last translation and verification for the same user interface of the software application. Additionally or alternatively, in some embodiments, the processor further applies one or more exceptions to the comparison, the one or more exceptions excluding at least one text from the output of the comparison. Additionally or alternatively, in some embodiments, the comparison of the one or more new hierarchy files with the one or more previously accepted hierarchy files comprises: parsing the one or more new hierarchy files; and parsing the one or more previously accepted hierarchy files, wherein the comparing the one or more new hierarchy files with the one or more previously accepted hierarchy files comprises performing a plain text comparison of the parsed one or more new hierarchy files and the parsed one or more previously accepted hierarchy files. Additionally or alternatively, in some embodiments, the presentation of the translation of the text that has changed comprises highlighting previous text in the one or more previously accepted screenshots, one or more previously accepted hierarchy files, or both, and highlighting the text that has changed in the one or more new screenshots, the one or more new hierarchy files, or both. Additionally or alternatively, in some embodiments, the display further presents a change history of the one or more new screenshots to the translator.

A non-transitory computer readable medium is disclosed. The computer readable medium includes instructions that, when executed, perform a method for translating or verifying text of a software application, the method comprises: receiving one or more new screenshots, one or more new hierarchy files, or both, of the software application; retrieving one or more previously accepted screenshots, one or more previously accepted hierarchy files, or both; comparing the one or more new screenshots with the one or more previously accepted screenshots, or the one or more new hierarchy files with the one or more previously accepted hierarchy files; locating text that has changed based on an output of the comparison; presenting a translation of the text that has changed to a translator for acceptance or rejection of the translation; and storing the one or more new screenshots, the one or more new hierarchy files, or both, when the translation has been accepted.

### BRIEF DESCRIPTION OF THE FIGURES

FIG. 1 illustrates a flowchart of an exemplary method for translating text in a user interface, according to some embodiments of the disclosure.

FIG. 2 illustrates a flowchart of an exemplary method for translating text that has changed in a software application, according to some embodiments of the disclosure.

FIG. 3 illustrates an exemplary system analyzing one or more user interfaces of a software application, according to some embodiments of the disclosure.

FIG. 4 illustrates an example change history user interface, according to some embodiments of the disclosure.

FIG. 5 illustrates an exemplary comparison user interface, according to some embodiments of the disclosure.

FIG. 6 illustrates a block diagram of an exemplary system, according to some embodiments of the disclosure.

### DETAILED DESCRIPTION

Disclosed herein are systems and methods for translating text for software applications. The text may be translated in a variety of different languages for the same software application. The text in the software application may change over time. Instead of translating all text (including both text that has changed and has not changed since the last accepted translation) and rebuilding the entire software application each time the text has changed, embodiments of the disclosure may include translating and/or verifying only the text that has changed and rebuilding only those portions of the software application that are affected by the text that has changed.

The system may receive one or more new screenshots having the text that has changed in the software application. The system may compare the new screenshot(s) with previously accepted screenshot(s) to locate the text that has changed. The previously accepted screenshot(s) may be from the last accepted translation. The text that has not changed (since the last accepted translation) may not be translated and/or verified once accepted by a translator. In this manner, the amount of time and costs may be reduced due to translating and verifying only the text that has changed since the last accepted translation.

The text that has changed may be translated by a translator. The translation with complete context of both new screenshot(s) and previously accepted screenshot(s) may be provided to a translator, who may accept or reject the translation. To reduce the amount of time needed for the translator to search for the text that has changed on a user interface, the system may highlight the text that has changed so that the translator may focus only on the relevant portions of the user interface and not have to search for the text that has changed. For rejected translations, the system may repeat the process, translating only the rejected text (instead of translating all text again). The amount of time and costs are further reduced by highlighting the portion(s) of a user interface that need verification by the translator. The accuracy of the translation is enhanced by providing complete context of both new screenshot(s) and previously accepted screenshot(s) to the translator.

When the text has changed, only those portions of the software application affected by the text that has changed are rebuilt, enhancing efficiency by avoiding having to rebuild the entire software application each time.

In the following description, for the purposes of explanation, numerous specific details are set forth in order to provide a thorough understanding of the present disclosure. It will be apparent, however, that embodiments may be practiced without these specific details. In other instances, well-known structures and devices are shown in block diagram form in order to avoid unnecessarily obscuring the present disclosure.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combination of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Traditional methods for translating text for a software application may involve translating and verifying text for the entire software application and rebuilding the app each time the text changes in the software application. This process may be time consuming, costly, and inaccurate, especially since the text in the software application may change frequently and the translations may be provided without complete context to a translator.

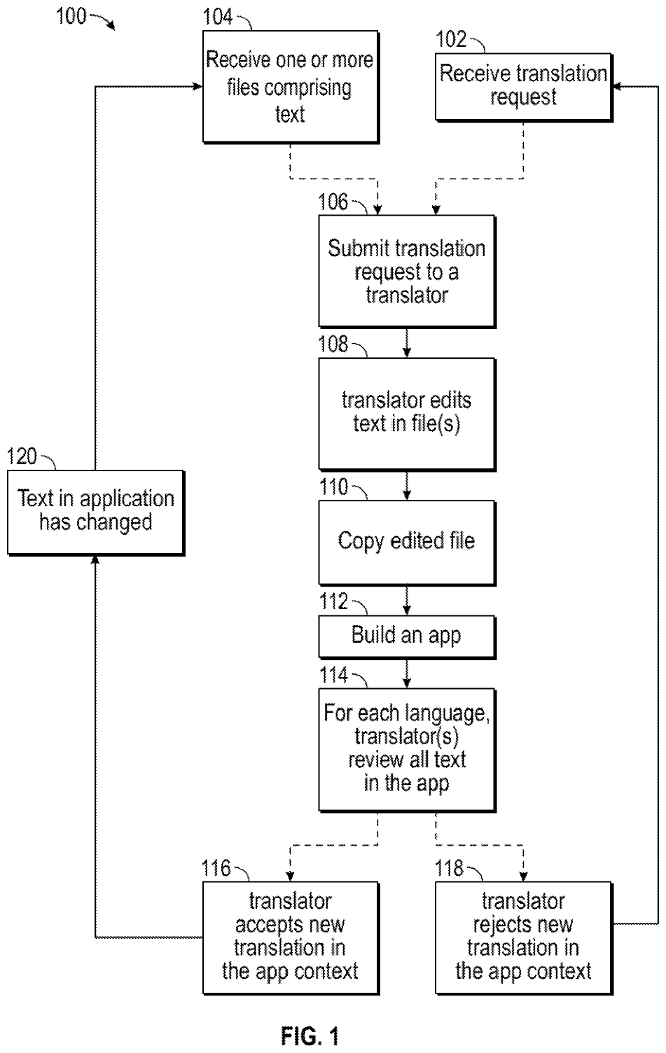

FIG. 1 illustrates a flowchart of an exemplary prior art method 100 for translating text in a user interface, according to some embodiments of the disclosure. In step 102, the system may receive a translation request. The translation request may be a request for translating one or more changes in text. The translation request may be received every time the text in a user interface changes, for example. In some embodiments, the translation request may be received at periodic intervals (e.g., daily, weekly, etc.) In step 104, the system may receive one or more files comprising text of the software application. The text may include text to be changed. The one or more files may be any type of file, such as a CSV file, an XML file, etc.

In step 106, the system may submit a translation request to a translator. The translation request may receive information from step 102, 104, or both. The translator may be a third-party language translator that translates text from a first language to a second language. The third-party language translator may be a cloud-based software service, SAAS product, etc. Exemplary third-party language translators may include, but are not limited to, Smartling, Crowdin, Memsource, etc. The translator may receive the file(s) and may edit the text in the file(s) (step 108). The text may be edited by replacing the text in the first language in the file with the text in the second language. For example, if the file has the text “hello” (in English) to be translated to French, the translator may replace the text in the first language “hello” with the text in the second language “ciao” in the file. In step 110, the edited file(s) may be copied to an application codebase. One non-limiting exemplary application codebase is CFV Android repo.

In step 112, the system may build an app. In some embodiments, the app may be built using a continuous integration and continuous delivery/deployment (CICD) pipeline. The app may be stored as an application file on an electronic device after being built. The app may be reviewed by one or more translators, who have to look for all text in the app (step 114). The review may comprise opening the app built for each language, going to each user interface, verifying that all text has the correct translation based on the user interface's context.

The translator may verify the new translation and accept it (step 116) or reject it (step 118). If the translator rejects the new translation, the system may repeat the process, attempting to translate all the text in all languages again. The verification and acceptance or rejection steps may comprise the translator looking at the text and corresponding new translation, and determining whether the new translation matches the correct translation of the text. If the new translation matches the correct translation of the text, then the translator may accept it by, e.g., clicking on a graphical user interface button corresponding to the acceptance. If the new translation does not match the correct translation of the text, then the translator may reject it by, e.g., clicking on a graphical user interface button corresponding to the rejection.

The method 100 may be repeated each time the user interface changes (or at periodic intervals), for the entirety of the app and each text on all user interfaces of the app (step 120). This may include translating and verifying text that has already been accurately translated. This process is extremely time consuming and costly, especially given the typical number of user interfaces for a given app, languages of interest, and changes made to an app or the frequency of the periodic intervals.

To reduce the time and costs required for translations, embodiments in the disclosure may include reducing the amount of text to be translated and verified. The system may locate only the text that has changed, which may be text that has changed (in the one or more new screenshots, the one or more new hierarchy files, or both) since the last accepted translation for the entire app or one or more user interfaces of the app. The text that has not changed (since the last accepted translation) may not be translated and/or verified once accepted. Additionally, in some embodiments, when a translator rejects a translation, only the rejected text is translated and verified again. In some embodiments, text that has already been translated and accepted may not again be translated and verified when the app is built. In some embodiments, text that has been translated and accepted may be translated and verified again at periodic intervals. Embodiments of the disclosure may reduce the number of periodic intervals (e.g., monthly instead of weekly, or weekly instead of daily, etc.).

Instead of translating all text and rebuilding the software application each time the text changes (or at periodic intervals), embodiments of the disclosure may include translating only the text that has changed and rebuilding only portions of the software application that are affected by the text that has changed.

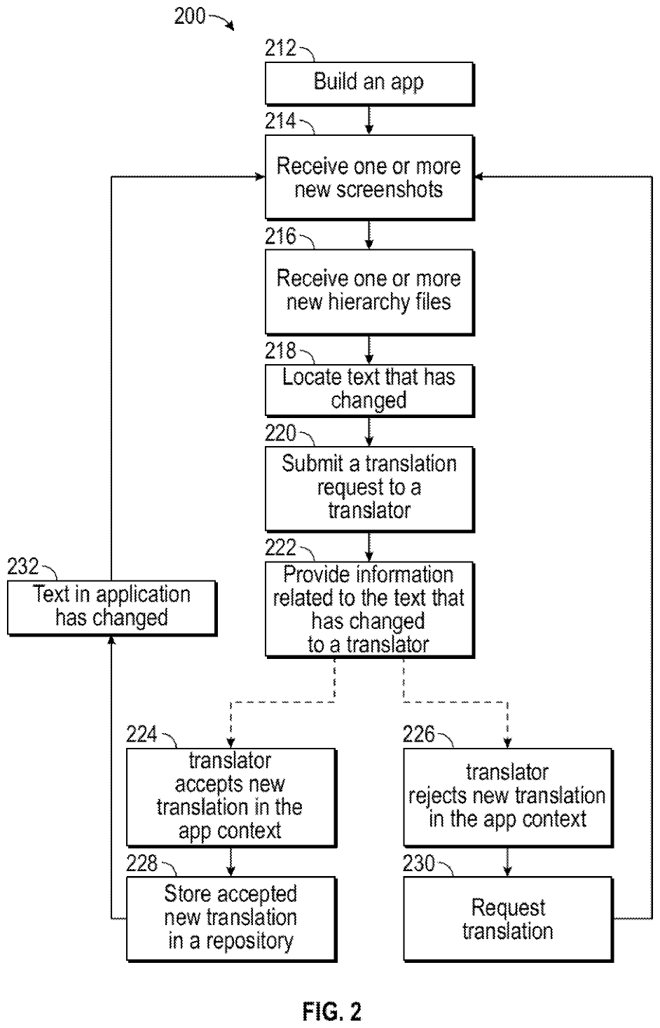

FIG. 2 illustrates a flowchart of an exemplary method 200 for translating and verifying text that has changed in a software application, according to some embodiments of the disclosure. The method 200 may include building an app in step 212.

In step 214, one or more new screenshots may be received. The new screenshot(s) may be manual captured and received as input from a user, for example.

In some embodiments, the app may be analyzed, capturing and collecting one or more new screenshots for one or more user interfaces in the app. For example, an app/user interface tester, such as Android Espresso or Firebase Test Lab, may run the software application, test the user interfaces, capture new screenshots, or a combination thereof. The new screenshots may be automatically captured. In some embodiments, this step may involve the system iterating through every user interface of an app.

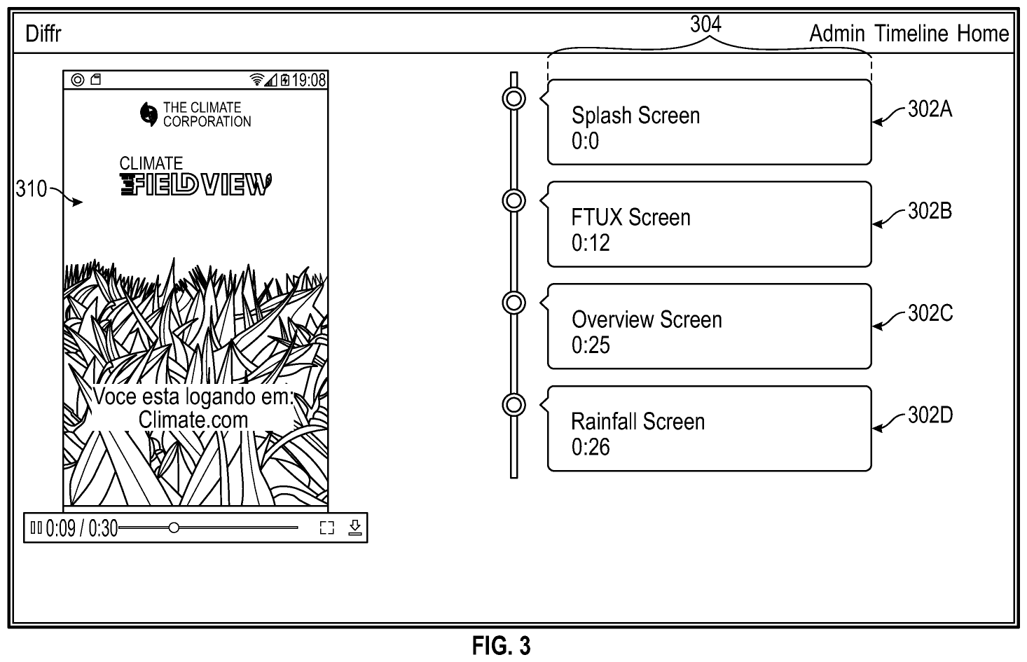

FIG. 3 illustrates an exemplary system analyzing an app by iterating through user interfaces of an app, as shown in window 310. While iterating through the user interfaces, the system may capture and collect the new screenshots of one or more user interfaces. The system may create corresponding entries 302. Each entry may be for a unique user interface, for example. In some embodiments, iterating through the user interfaces may include reviewing a video (shown in window 310) that runs through the app. The entries 302 may be displayed in a timeline 304. An entry 302 may include information, such as, but not limited to, the corresponding user interface name and a timestamp from the video. For example, a first entry 302A may be a screenshot of a “Splash Screen” having a timestamp of 0:0; a second entry 302B may be a screenshot of a “FTUX Screen” having a timestamp of 0:12; a third entry 302C may be a screenshot of an “Overview Screen” having a timestamp of 0:25; and a fourth entry 302D may be a screenshot of a “Rainfall Screen” having a timestamp of 0:26. Embodiments of the disclosure may include, but are not limited to, a web framework, such as Python Django, Flash, Pyramid, etc. for analyzing an app.

Returning to step 214 of FIG. 2, in some embodiments, the system may receive the new screenshot(s) by automatically capturing and collecting them. The system may capture and collect new screenshots for all languages of interest. The set of collected new screenshots for all the languages of interest may have the same corresponding screenshot(s) (the language of translation being the only difference). The system may save the collected new screenshots. In some embodiments, the system may capture and collect new screenshots for only certain languages (e.g., less than all languages of interest).

The system may receive one or more hierarchy files in step 216. A hierarchy file may be a file that represents the structure (e.g., order, relationships, content, etc.) of the screenshots in an app. The one or more hierarchy files may be new hierarchy file(s) corresponding to the new screenshot(s). In some embodiments, a hierarchy files may be structured in a Document Object Model (DOM) hierarchy. The hierarchy file may be an XML file, for example.

The system may retrieve corresponding previously accepted screenshot(s) and/or associated previously accepted hierarchy file(s) from a repository and may perform a comparison. In some embodiments, the corresponding previously accepted screenshot may be the same as the new screenshot except for the text that has changed. The comparison may include comparing the new screenshot(s) with corresponding previously accepted screenshot(s). Additionally or alternatively, the comparison may include comparing the new hierarchy file(s) with corresponding previously accepted hierarchy file(s).

The system may locate the text that has changed in step 218. For example, the system may parse the hierarchy files to locate the text that has changed in the software application. In some embodiments, an XML parser, such as Python lxml or BeautifulSoup, may be used to parse the hierarchy files. The system may locate the text that has changed by determining differences in the text using a comparison of the hierarchy files corresponding to the previously accepted screenshot and the new screenshot. In some embodiments, step 218 may include inputting labels and/or tags into an application programming interface (API). The tags may indicate which elements in the hierarchy files have relevant changes. The tagged elements may be later used for when highlighting the text that has changed (discussed below). The API may output the hierarchy file(s). The API may be a cross platform test automation tool like Appium or Cypress, for example.

To perform the comparison, in some embodiments, the system may navigate down the new and previously accepted hierarchy files and do a plain text comparison between the two, e.g., using a script. In some embodiments, one or more exceptions may be applied to the comparison such that at least one text that has changed may be excluded from the output of the comparison. For example, date and time changes may be excluded from the comparison.

Additionally or alternatively, the system may determine differences in text by comparing the previously accepted screenshot and the new screenshot. In some embodiments, the system may extract the text information out of the images using, e.g., image recognition. The system may selectively extract the text information out of the image when the text is within the image itself, for example. Embodiments may include determining differences by comparing the page structure, element structure, images, or a combination thereof, between screenshots and/or hierarchy files.

The output from the comparison may include a list of the text that has changed. In some embodiments, this step may be performed without requiring an optical character recognition step. In some embodiments, the system may not need to detect visual changes (e.g., layout changes, color changes, etc.)

The comparison may show differences in properties between the previously accepted screenshot and the new screenshot. As one non-limiting example, a repository manager, like Gitlab or Jenkins, may be used to show differences in the hierarchy files, screenshots, or both.

From the differences, the system may determine which text has changed and corresponding screenshots. For the screenshots associated with the text that has changed, the system may provide the previously accepted screenshot (having the previously accepted translation) and the corresponding new screenshot (having the text that has changed).

In some embodiments, the system may have a new screenshot of every user interface of an app. For example, an app may have four user interfaces, and the system may capture four new screenshots. The system may determine which screenshots have the text that has changed. The system may determine at least one new screenshot that does not have text that has changed. The system may discard the at least one new screenshot, a corresponding at least one new hierarchy file, or both, that does not have text that has changed. In some embodiments, the determination of which screenshots have text that has changed may occur after the screenshots have been captured. The system may collect the new screenshots that have not been discarded.

In some embodiments, the system may determine whether a given new screenshot has text that has changed after capturing the new screenshots. In this manner, the system may not collect screenshots that do not have text has changed. For example, the system may determine there are two of the four user interfaces with text that has changed, and the system may collect two new screenshots. In some embodiments, the system may not collect at least one screenshot for a user interface.

In step 220, the system may submit a translation request to a translator. The translator may be a third-party language translator such as Smartling, Crowdin, Memsource, etc. The system may send the translator one or more files, and the translator may edit the text that has changed in the file(s). The file(s) may comprise only the text that has changed. The edited text may replace the previous text that has changed in the file(s) with a translated version. For example, if the file has the text “hello” to be translated to French, the translator may replace the text “hello” with “ciao” in the file. In some embodiments, the translator may replace the text that has changed in a plurality of files, where each file may be for a unique language. For example, a first file may be for French, a second file may be for Spanish, and third file may be for Japanese, etc. This step may comprise translating one file and one language at a time. The translator may replace all text in the file with the translated text for a given language, and then proceed with files for the other languages of interest. Alternatively, the step may comprise translating one text that has changed for all languages of interest at a time. For each text, the translator may replace the text in all files for all languages, and then proceed with the next text, where the process is repeated until all text in the file have been translated.

In step 222, the system may provide information related to the text that has changed to a translator. The system may present (e.g., display) the previously accepted screenshot (having the previously accepted translation) and the corresponding new screenshot (having the text that has changed) to the translator. In some embodiments, the previous text in the previously accepted screenshot (or previously accepted hierarchy file) and the text that has changed in the new screenshot (or new hierarchy file) may be highlighted (e.g., by changing the color of the text that has changed or surrounding background, adding a box around the text that has changed, etc.) to the translator.

In some embodiments, step 222 may involve a notification to the translator. The notification may inform the translator that text in the software application has changed. The notification may be triggered by the detection of the text that has changed in step 214. In some embodiments, the system may not notify the translator when the only changes involved are changes to images.

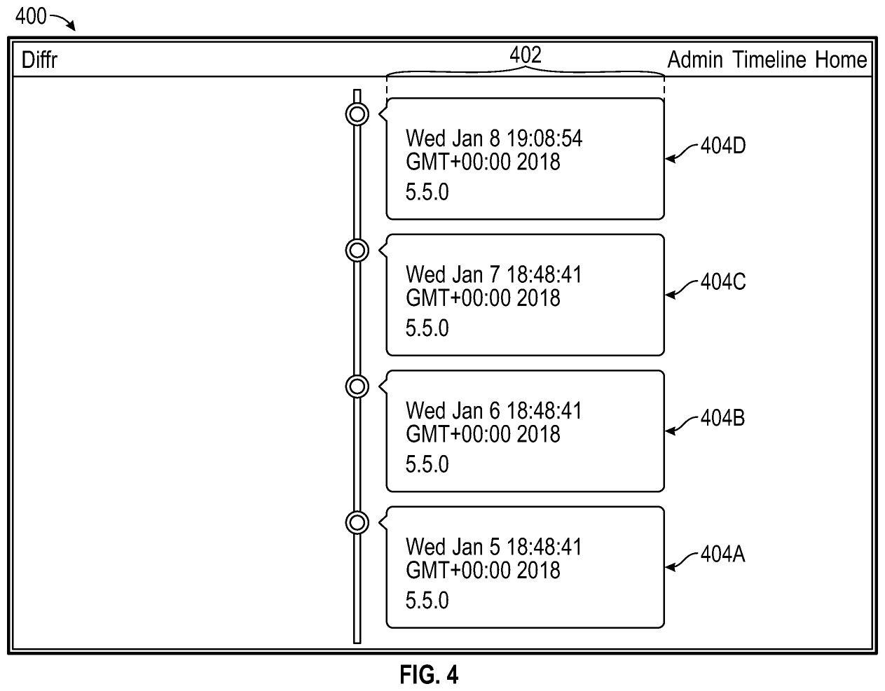

In some embodiments, the system may allow a translator to look at a screenshot's change history. The screenshot's change history may provide more context to the translator, which may lead to a more accurate translation. FIG. 4 illustrates an example change history user interface 400, according to some embodiments of the disclosure. The system may present the change history of the one or more new screenshots to the translator. The timeline 402 may include entries 404 for a plurality of screenshots for a given user interface. In some embodiments, each entry 404 may include a timestamp for the corresponding screenshot. For example, the timeline 402 shown in the figure may have four entries 404, reflecting the changes to the same user interface. The first entry 404A shows a first change (or the initial user interface) on January 5^{th} at 18:48:41; the second entry 404B shows a second change on January 6^{th} at 18:48:41; the third entry 404C shows a third change on January 7^{th} at 18:48:41; and the fourth entry 404D shows a fourth change on January 8^{th} at 19:08:54. The translator may select which screenshot to use for determining whether to accept or reject the new translation. As non-limiting examples, Gitlab, Azure, or Bitbucket may be used to maintain the history of changes.

In some embodiments, the system may allow interactive controls to be overlaid on the comparison, the new screenshots, or both. The interactive controls may allow the user to hover over the text that has changed. The system may highlight where the text was in the previous screenshot. In some embodiments, the system may provide a button that allows the user to verify the change by accepting or rejecting it. If the user accepts the change (using the button), then the system may automatically update accept the translation. If the user rejects the change (using the button), the system may automatically submit a request for a translation. The request for translation may include providing the translator with the screenshot for context.

In some embodiments, the system may allow visual cues to be applied to the comparison, the new screenshots, or both. A visual cue may be a highlighted box in the screenshot. The highlighted box may surround the text that has changed.

Embodiments of the disclosure may include providing a translator with one or more screenshots (previously accepted, new, or both), one or more corresponding hierarchy files (previously accepted, new, or both), or both. The system may display a screenshot (previously accepted, new, or both) of the user interface of interest to provide the translator with complete context while verifying the translation. The information provided to the translator may be through a dashboard user interface. The dashboard user interface may show differences between days, for example.

To provide complete context to the translator, the system may present side-by-side views of the new screenshot(s) information (having the text that has changed) and the previous screenshot(s) information (e.g., from the last translation and verification).

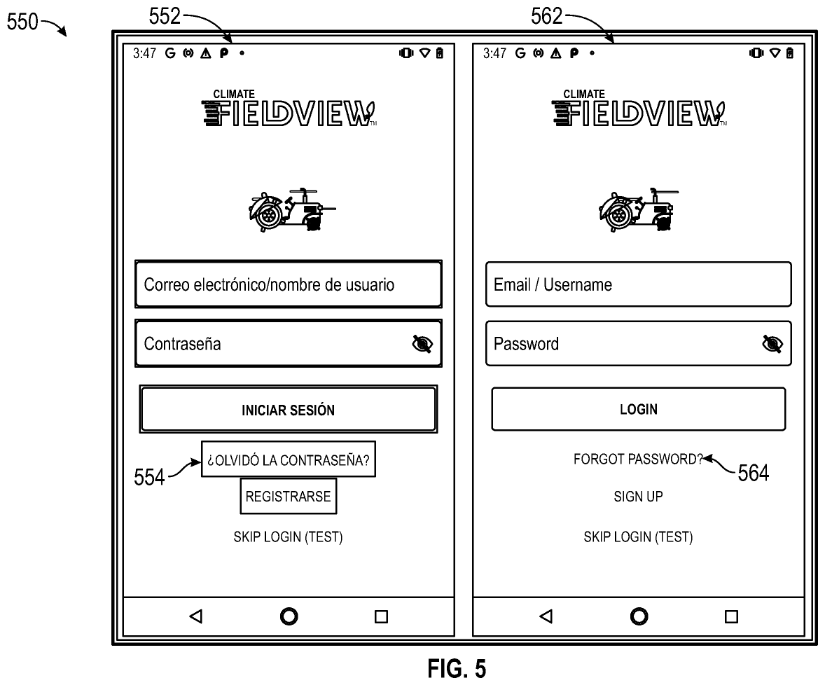

FIG. 5 illustrates an exemplary comparison user interface 550, according to some embodiments of the disclosure. The comparison user interface 550 may allow a translator to compare the screenshots with context. For example, the user interface 562 (shown on the right side of the figure) may be the original screenshot, while the user interface 552 (shown on the left side of the figure) may be the translated screenshot. The translator may review translated text 564 and determine whether it is the proper translation for corresponding text 554, for example.

In some embodiments, the system may allow a translator to overlay interactive controls and apply visual cues. The system may display side-by-side lists and text in the previously accepted screenshot and the new screenshot, respectively. In some embodiments, the system may highlight the text that has changed. For example, the system may highlight the text (e.g., “Kansas 1”) in the new screenshot, but the same text may not be in the previously accepted screenshot. The system may highlight the text that has changed so that the translator may spend his or her time verifying only those portions of the user interface that has the text that has changed.

Returning to method 200 in FIG. 2, the translator may verify the new translation and either accept it (step 224) or reject it (step 226). If the translator accepts the new translation, then in step 228, the corresponding hierarchy file, raw text file, screenshot, or a combination thereof may be stored in a repository. If the translator rejects the new translation, then in step 230, the system may submit a translation request to a translator for the rejected translation. The translation request may include only the text that has changed, the new screenshot, the new hierarchy file, or a combination thereof. Alternatively, the system may allow the translator to manually enter the correct translation.

Embodiments of the disclosure may also include simplifying the verification process. The verification process may include providing contextual screenshots of the text that has changed, instead of providing the entire user interface. When provided with the entire user interface, a translator may have to spend time trying to locate the corresponding portion of the user interface having the text that has changed. The contextual screenshots may focus the human translator on the portion of interest while providing the requisite context to accurately determine whether the translation should be accepted or rejected. The verification may involve a binary decision approval process. For example, the translator may be able to view the contextual screenshots and either accept or reject the translation.

In step 232, text in the software application may change. When the text has changed, steps 214-230 are repeated using only the new screenshot(s) and/or new hierarchy file(s) affected by the text that has changed. A build of the entire software application and a translation of all text in the software application may be avoided, thereby reducing the amount of time and costs required in translating and/or verifying the software application.

In some embodiment, the entire software application may be built again, where steps 212-230 are repeated.

The application may be released once built (e.g., in a continuous integration continuous deployment (CICD) system). In some embodiments, the application may be built, but deployed with the next release of the application.

The above disclosed embodiments may be used to automatically provide screenshots in the original language to the translator for context when translating to different languages and verifying.

Additionally or alternatively, in some embodiments, the system may generate a screenshots from the one or more hierarchy files. The generated screenshot may then be verified and used in the above disclosed process.

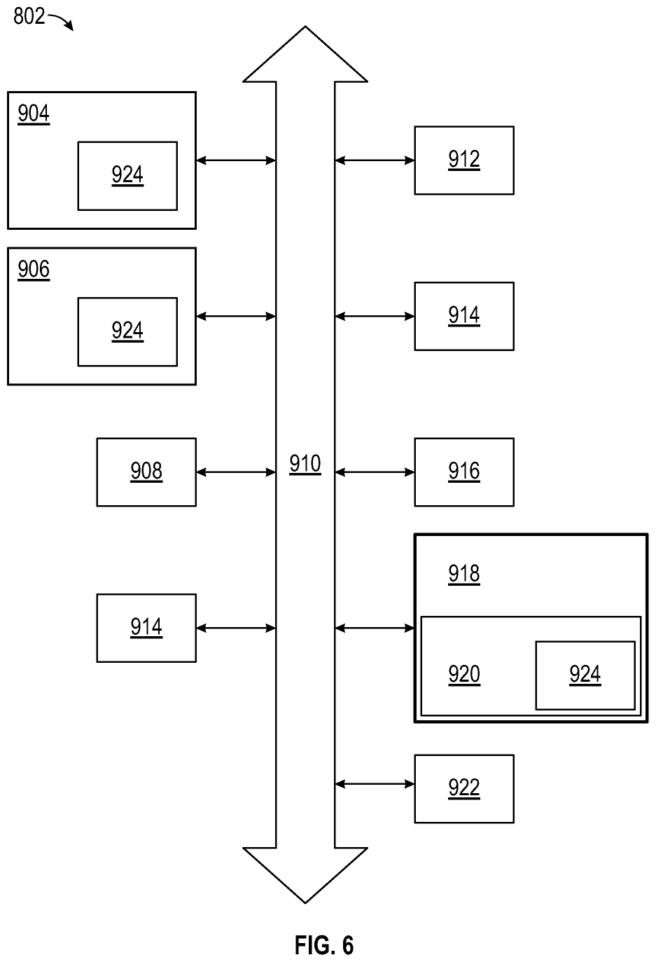

FIG. 6 illustrates a block diagram of an exemplary system 802, according to embodiments of the disclosure. The system may be a machine such as a computer, within which non-transitory computer readable medium including instructions that cause the machine to perform any one of the steps and processes discussed herein, according to embodiments of the disclosure. In some embodiments, the machine can operate as a standalone device or may be connected (e.g., networked) to other machines. In a networked configuration, the machine may operate in the capacity of a server or a client machine in a server-client network environment, or as a peer machine in a peer-to-peer (or distributed) network environment. The machine can be a personal computer (PC), a tablet PC, a set-top box (STB), a personal digital assistant (PDA), a cellular telephone, a web appliance, a network router, a switch or bridge, or any machine capable of executing a set of instructions (sequential or otherwise) that specify actions to be taken by that machine. A mobile device such as a PDA or a cellular phone may also include an antenna, a chip for sending and receiving radio frequency transmissions and communicating over cellular phone WAP and SMS networks, and a built-in keyboard. Further, while only a single machine is illustrated, the term “machine” shall also be taken to include any collection of machines that individually or jointly execute a set (or multiple sets) of instructions to perform any one of the methodologies discussed herein.

The exemplary computer 802 includes a processor 904 (e.g., a central processing unit (CPU), a graphics processing unit (GPU), or both), a main memory 906 (e.g., read-only memory (ROM), flash memory, dynamic random access memory (DRAM) such as synchronous DRAM (SDRAM) or Rambus DRAM (RDRAM), etc.), and a static memory 908 (e.g., flash memory, static random access memory (SRAM), etc.), which can communicate with each other via a bus 910.

The computer 802 may further include a video display 912 (e.g., a liquid crystal display (LCD) or a cathode ray tube (CRT)). The computer 802 also includes an alpha-numeric input device 914 (e.g., a keyboard), a cursor control device 916 (e.g., a mouse), a disk drive unit 918, a signal generation device 920 (e.g., a speaker), and a network interface device 922.

The drive unit 918 includes a machine-readable medium 920 on which is stored one or more sets of instructions 924 (e.g., software) embodying any one or more of the methodologies or functions described herein. The software may also reside, completely or at least partially, within the main memory 906 and/or within the processor 904 during execution thereof by the computer 802, the main memory 906 and the processor 904 also constituting machine-readable media. The software may further be transmitted or received over a network 804 via the network interface device 922.

While the machine-readable medium 920 is shown in an exemplary embodiment to be a single medium, the term “non-transitory computer-readable medium” should be taken to include a single medium or multiple media (e.g., a centralized or distributed database and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

What is claimed is:

1. A computer-implemented method for translating or verifying text of a software application, the method comprising:
receiving one or more new screenshots, one or more new hierarchy files, or both, of the software application;
retrieving one or more previously accepted screenshots, one or more previously accepted hierarchy files, or both;
comparing the one or more new screenshots with the one or more previously accepted screenshots, or the one or more new hierarchy files with the one or more previously accepted hierarchy files;
locating text that has changed based on an output of the comparison;
presenting a translation of the text that has changed to a translator for acceptance or rejection of the translation; and
storing the one or more new screenshots, the one or more new hierarchy files, or both, when the translation has been accepted.

2. The computer-implemented method of claim 1, wherein the one or more previously accepted screenshots and the one or more previously accepted hierarchy files are from a last translation and verification for the same user interface of the software application.

3. The computer-implemented method of claim 1, further comprising:
applying one or more exceptions to the comparison, the one or more exceptions excluding at least one text from the output of the comparison.

4. The computer-implemented method of claim 1, wherein the comparing the one or more new hierarchy files with the one or more previously accepted hierarchy files comprises:
parsing the one or more new hierarchy files; and
parsing the one or more previously accepted hierarchy files; wherein the comparing the one or more new hierarchy files with the one or more previously accepted hierarchy files comprises performing a plain text comparison of the parsed one or more new hierarchy files and the parsed one or more previously accepted hierarchy files.

5. The computer-implemented method of claim 1, wherein the comparing comprises determining differences in page structure, element structure, or images.

6. The computer-implemented method of claim 1, wherein the presenting the translation of the text that has changed comprises highlighting previous text in the one or more previously accepted screenshots, one or more previously accepted hierarchy files, or both, and highlighting the text that has changed in the one or more new screenshots, the one or more new hierarchy files, or both.

7. The computer-implemented method of claim 1, further comprising:
presenting a change history of the one or more new screenshots to the translator.

8. The computer-implemented method of claim 1, further comprising:
collecting and capturing the one or more new screenshots, the one or more new hierarchy files, or both, of the software application.

9. The computer-implemented method of claim 8, wherein the one or more new screenshots collected are not for all languages of interest.

10. The computer-implemented method of claim 8, wherein the collecting and capturing comprises iterating through every user interface of the software application.

11. The computer-implemented method of claim 8, further comprising:
determining that at least one screenshot does not have the text that has changed; and
discarding the at least one screenshot, a corresponding at least one hierarchy file, or both.

12. The computer-implemented method of claim 1, further comprising:
submitting a translation request of the text that has changed to the translator; and
receiving the translation of the text that has changed from the translator.

13. The computer-implemented method of claim 12, wherein the submitting the translation request comprises sending one or more files to the translator, the one or more files including only the text that has changed.

14. A system for translating text of a software application, the system comprising:
a memory that stores one or more previously accepted screenshots, one or more previously accepted hierarchy files, or both;
a processor that:
receives one or more new screenshots, one or more new hierarchy files, or both, of the software application;
retrieves the one or more previously accepted screenshots, the one or more previously accepted hierarchy files, or both from the memory;
compares the one or more new screenshots with the one or more previously accepted screenshots, or the one or more new hierarchy files with the one or more previously accepted hierarchy files;
stores the one or more new screenshots, the one or more new hierarchy files, or both, when the translation has been accepted; and
locates text that has changed based on an output of the comparison; and
a display that presents a translation of the text that has changed to a translator for acceptance or rejection of the translation.

15. The system of claim 14, wherein the one or more previously accepted screenshots and the one or more previously accepted hierarchy files are from a last translation and verification for the same user interface of the software application.

16. The system of claim 14, wherein the processor further applies one or more exceptions to the comparison, the one or more exceptions excluding at least one text from the output of the comparison.

17. The system of claim 14, wherein the comparison of the one or more new hierarchy files with the one or more previously accepted hierarchy files comprises:
parsing the one or more new hierarchy files; and
parsing the one or more previously accepted hierarchy files;
wherein the comparing the one or more new hierarchy files with the one or more previously accepted hierarchy files comprises performing a plain text comparison of the parsed one or more new hierarchy files and the parsed one or more previously accepted hierarchy files.

18. The system of claim 14, wherein the presentation of the translation of the text that has changed comprises highlighting previous text in the one or more previously accepted screenshots, one or more previously accepted hierarchy files, or both, and highlighting the text that has changed in the one or more new screenshots, the one or more new hierarchy files, or both.

19. The system of claim 14, wherein the display further presents a change history of the one or more new screenshots to the translator.

20. A non-transitory computer readable medium, the computer readable medium including instructions that, when executed, perform a method for translating or verifying text of a software application, the method comprising:
receiving one or more new screenshots, one or more new hierarchy files, or both, of the software application;
retrieving one or more previously accepted screenshots, one or more previously accepted hierarchy files, or both;
comparing the one or more new screenshots with the one or more previously accepted screenshots, or the one or more new hierarchy files with the one or more previously accepted hierarchy files;
locating text that has changed based on an output of the comparison;
presenting a translation of the text that has changed to a translator for acceptance or rejection of the translation; and
storing the one or more new screenshots, the one or more new hierarchy files, or both, when the translation has been accepted.
